(19) United States
(12) Patent Application Publication
(10) Pub. No.: US 2024/0161948 A1
(43) Pub. Date: May 16, 2024

(54) CHIP RESISTOR

(71) Applicant: Panasonic Intellectual Property Management Co., Ltd., Osaka (JP)

(72) Inventors: Takashi OHBAYASHI, Osaka (JP); Junko ONOZAKI, Hokkaido (JP); Hirokatsu ITO, Fukui (JP); Kyousuke ISONO, Osaka (JP)

(21) Appl. No.: 18/255,989

(22) PCT Filed: Dec. 6, 2021
(86) PCT No.: PCT/JP2021/044708

§ 371 Date: Dec. 19, 2023

(30) Foreign Application Priority Data
Dec. 7, 2020 (JP) 2020-202863

(51) Int. Cl. H01C 1/02; C09D 7/40; C09D 7/61; C09D 7/65; C09D 163/04

(52) U.S. Cl. CPC H01C 1/02; C09D 7/61; C09D 7/65; C09D 7/69; C09D 163/04

(57) ABSTRACT

A chip resistor includes: a resistor body; and a protective coating that covers the resistor body. The protective coating is a cured product of a coating agent containing a polyfunctional epoxy resin, a curing agent, an inorganic filler, and silicone rubber particles. The coating agent contains: silica as the inorganic filler at a content equal to or greater than 60% by weight and equal to or less than 90% by weight; and the silicone rubber particles at a content equal to or greater than 1% by weight and equal to or less than 15% by weight.

### TECHNICAL FIELD

The present disclosure generally relates to a chip resistor, and more particularly relates to a chip resistor including a resistor body and a protective coating.

### BACKGROUND ART

Patent Literature 1 discloses a resin composition including a naphthylene-ether epoxy resin (A), an amine-based curing agent (B), and an inorganic filler (C) containing at least talc (c1). Patent Literature 1 also teaches that the content of the component (c1) falls within the range from 15 parts by mass to 40 parts by mass with respect to 100 parts by mass in total of the components (A), (B), and (C). Patent Literature 1 further discloses a coating agent including the resin composition and used as a material for a protective coating for a chip resistor, a protective coating for a chip resistor as a cured product of the resin composition, and a chip resistor including the protective coating.

### CITATION LIST

### Patent Literature

Patent Literature 1: JP 2018-145410 A

### SUMMARY OF INVENTION

Such a chip resistor is required to reduce the chances of causing peeling between a protective coating and an underlying member on which the protective coating is formed and also reduce the chances of allowing water to enter the chip resistor through the gap between the protective coating and the underlying member.

It is therefore an object of the present disclosure to provide a chip resistor that reduces the chances of causing peeling between a protective coating and an underlying member and also reduces the chances of allowing water to enter the chip resistor through the gap between the protective coating and the underlying member.

A chip resistor according to an aspect of the present disclosure includes: a resistor body; and a protective coating that covers the resistor body. The protective coating is a cured product of a coating agent containing a polyfunctional epoxy resin, a curing agent, an inorganic filler, and silicone rubber particles. The coating agent contains silica as the inorganic filler at a content equal to or greater than 60% by weight and equal to or less than 90% by weight and also contains the silicone rubber particles at a content equal to or greater than 1% by weight and equal to or less than 15% by weight.

### BRIEF DESCRIPTION OF DRAWINGS

FIG. 1 is a cross-sectional view illustrating a chip resistor according to an exemplary embodiment:

FIG. 2 illustrates a protective coating for the chip resistor according to the exemplary embodiment;

FIGS. 3A-3C illustrate respective manufacturing process steps of the chip resistor according to the exemplary embodiment; and

FIGS. 4A-4H illustrate respective manufacturing process steps of the chip resistor according to the exemplary embodiment.

### DESCRIPTION OF EMBODIMENTS

1. Overview

First, it will be described how the present inventors conceived the concept of a chip resistor according to an exemplary embodiment.

Recently, a protective coating provided for a chip resistor has often been required to exhibit higher and higher heat resistance. Thus, nowadays, the protective coating needs to exhibit heat resistance that is high enough to avoid causing cracking or chipping even when subjected to a heat cycle of −55° C./175° C., which is more severe than the traditional one.

To form a protective coating with high heat resistance, a resin composition including a polyfunctional epoxy resin such as a novolac epoxy resin has been used. A protective coating, which is a cured product of such a resin composition including a polyfunctional epoxy resin, certainly has increased heat resistance. However, such a protective coating shrinks significantly when cured and exhibits poor adhesion to the underlying member, thus sometimes causing peeling between the protective coating and the underlying member or allowing water to permeate through the gap (or interface) between the protective coating and the underlying member at the time of a humidity load life test, for example. If water permeates through the gap between the protective coating and the underlying member, then the resistance value of the chip resistor may vary.

Thus, in the chip resistor according to this embodiment, the protective coating that covers the resistor body is formed out of a cured product of a coating agent containing a polyfunctional epoxy resin, a curing agent, an inorganic filler, and silicone rubber particles. The coating agent contains silica as the inorganic filler at a content equal to or greater than 60% by weight and equal to or less than 90% by weight and also contains the silicone rubber particles at a content equal to or greater than 1% by weight and equal to or less than 15% by weight.

Such a protective coating for a chip resistor includes a cured product of a polyfunctional epoxy resin, and therefore, has high heat resistance. In addition, the stress caused when the polyfunctional epoxy resin is cured and shrinks is relaxed by silica and silicone rubber particles.

This reduces the chances of causing a decline in adhesion of the protective coating to the underlying member, on which the protective coating is formed, and thereby reduces the chances of causing peeling between the protective coating and the underlying member. This also reduces the chances of allowing water entering the chip resistor through the gap between the protective coating and the underlying member. Consequently, this makes it easier to reduce the variation in the resistance value of the chip resistor.

In the chip resistor according to this embodiment, silica is preferably particles having a mean particle size equal to or greater than 1 μm and equal to or less than 10 μm. The silicone rubber particles preferably have a mean particle size equal to or greater than 2 μm and equal to or less than 15 μm and have a rubber hardness equal to or greater than 10 and equal to or less than 35 when measured with a durometer.

This makes it easier for the silica particles and the silicone rubber particles to further increase the stress relaxation effect of the protective coating, thus reducing the chances of causing peeling between the protective coating and the underlying member and reducing the chances of water permeating through the gap between the protective coating and the underlying member.

Also, in a chip resistor according to this embodiment, the polyfunctional epoxy resin preferably includes a tetrafunctional hydroxyphenyl epoxy resin.

This increases the flexibility of the protective coating and reduces the chances of causing cracking and chipping to the protective coating at the time of a heat cycle test, compared to a situation where the protective coating includes any other polyfunctional epoxy resin.

2. Details

2-1. Chip Resistor

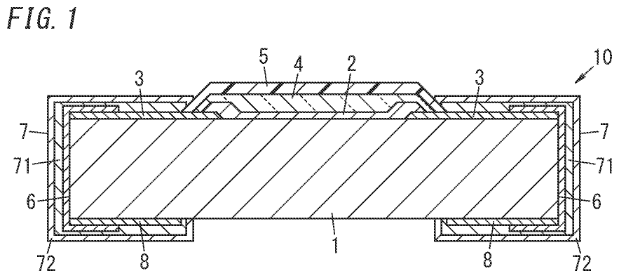

FIG. 1 illustrates a chip resistor 10 according to this embodiment. The chip resistor 10 may be, for example, a surface-mounted (SMT) chip resistor to be mounted on the surface (i.e., mounting surface) of a printed wiring board using a surface mounter. Furthermore, the chip resistor 10 may be, for example, a thick film chip resistor.

As shown in FIG. 1, the chip resistor 10 according to this embodiment includes a resistor body 2 and a protective coating 5. The chip resistor 10 further includes an insulating substrate 1, a pair of surface electrodes 3, an undercoat protective film 4, a pair of end face electrodes 6, a pair of plating layers 7, and a pair of back surface electrodes 8.

The insulating substrate 1 may be, for example, an alumina substrate containing 96% to 99% of Al₂O₃(alumina). When viewed in plan (i.e., when viewed from over the paper of FIG. 1), the insulating substrate 1 may have, for example, a rectangular shape such as an oblong shape.

The resistor body 2 has electrical resistance, is a thick film, and is provided on one surface (i.e., the upper surface in FIG. 1) of the insulating substrate 1. The resistor body 2 may be made of RuO₂, AgPd, or CuNi, for example, is located in a substantially central area of the insulating substrate 1, and has a rectangular shape such as an oblong shape in plan view.

Each of the pair of surface electrodes 3 may be formed, for example, as an Ag-based cermet thick-film electrode. The pair of surface electrodes 3 are electrically connected to the resistor body 2 at both longitudinal ends of the resistor body 2 (i.e., at both ends in the rightward/leftward direction shown in FIG. 1). One end portion of each surface electrode 3 is located under the resistor body 2 and the other end portion thereof is located at either the right end or left end of the insulating substrate 1.

The undercoat protective film (precoat glass film) 4 is a film for protecting the resistor body 2. The undercoat protective film 4 also serves as an undercoat film for the protective coating 5. That is to say, the protective coating 5 is formed over the undercoat protective film 4 and the undercoat protective film 4 is provided between the protective coating 5 and the resistor body 2. The undercoat protective film 4 is made of an inorganic material. Examples of the inorganic material include glass materials such as crystal glass or quartz glass and Al₂O₃(alumina). The undercoat protective film 4 is located on the upper surface of the resistor body 2. The undercoat protective film 4 partially covers the pair of surface electrodes 3 at both longitudinal ends thereof (i.e., at both ends in the rightward/leftward direction shown in FIG. 1). That is to say, when viewed in the thickness direction defined for the resistor body 2 (i.e., in the thickness direction defined for the insulating substrate 1), the undercoat protective film 4 covers the boundary between the resistor body 2 and the pair of surface electrodes 3 and continuously covers a range from the resistor body 2 through at least respective parts of the pair of surface electrodes 3.

As can be seen, providing the undercoat protective film 4 enables preventing the resistor body 2 from corroding. Alternatively, the undercoat protective film 4 may also be made of any suitable metal oxide other than alumina or a metal nitride.

The protective coating 5 is a coating for protecting the resistor body 2. The protective coating 5 is made of a cured product of a coating agent including an epoxy resin. The protective coating 5 covers the entire surface of the undercoat protective film 4 and respective parts of the pair of surface electrodes 3. That is to say, when viewed in the thickness direction defined for the resistor body 2, the protective coating 5 covers the boundary between the undercoat protective film 4 and the pair of surface electrodes 3 and continuously covers a range from the undercoat protective film 4 through at least respective parts of the pair of surface electrodes 3. Therefore, the protective coating 5 covers the resistor body 2. The protective coating 5 may have a rectangular shape such as an oblong shape when viewed in plan. Respective parts, located between both longitudinal end portions of the undercoat protective film 4 (i.e., both end portions thereof in the rightward/leftward direction shown in FIG. 1) and the plating layers 7, of the pair of surface electrodes 3 are directly covered with the protective coating 5.

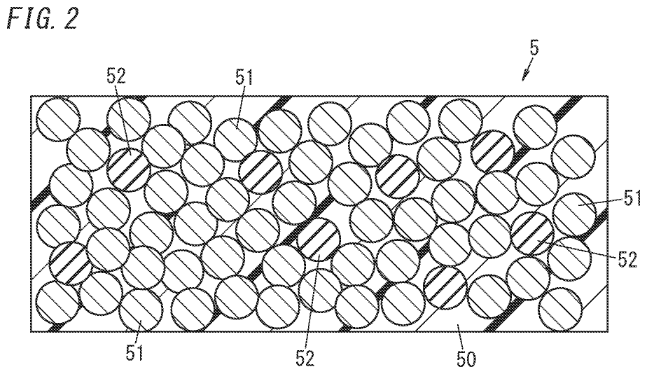

FIG. 2 illustrates the protective coating 5. The protective coating 5 includes a resin portion 50, silica particles 51, and silicone rubber particles 52. The resin portion 50 is a cured product of a resin. A plurality of silica particles 51 and a plurality of silicone rubber particles 52 are dispersed in the resin portion 50 in the shape of a film. The protective coating 5 includes the plurality of silica particles 51 and the plurality of silicone rubber particles 52. This allows the protective coating 5 to relax the stress caused to the protective coating 5 due to heat, for example, compared to a situation where the protective coating 5 is formed out of the resin portion 50 alone. That is to say, the protective coating 5 includes the plurality of silica particles 51, and therefore. may reduce a difference in the coefficient of linear expansion from the adjacent undercoat protective film 4 made of an inorganic material, compared to a situation where the protective coating 5 is formed out of the resin portion 50 alone. This makes it easier for the thermal expansion and shrinkage of the protective coating 5 to follow the thermal expansion and shrinkage of the undercoat protective film 4. This reduces the chances of causing stress to the protective coating 5 even if the protective coating 5 and the undercoat protective film 4 are bonded or adhere to each other. In addition, the protective coating 5 includes the plurality of silica particles 51. This allows the stress caused to the protective coating 5 to be absorbed more easily by elastic deformation of the plurality of silicone rubber particles 52, compared to a situation where the protective coating 5 is formed out of the resin portion 50 alone. Consequently, the stress caused to the protective coating 5 may be relaxed.

Each of the pair of end face electrodes 6 may be made of, for example, Ag. The pair of end face electrodes 6 are respectively located at both longitudinal ends of the insulating substrate 1 (i.e., both ends in the rightward/leftward direction shown in FIG. 1). The pair of end face electrodes 6 are electrically connected to the pair of surface electrodes 3.

Each of the pair of plating layers 7 includes an Ni plating layer 71 and an Sn plating layer 72 as shown in FIG. 1. Each of the pair of plating layers 7 is connected to a part of a corresponding one of the pair of surface electrodes 3 and is in contact with the protective coating 5. In addition, each of the pair of plating layers 7 covers a corresponding one of the pair of end face electrodes 6.

Each of the pair of back surface electrodes 8 may be formed, for example, as an Ag-based cermet thick-film electrode. The pair of back surface electrodes 8 are located at both longitudinal ends of the back surface (i.e., the lower surface shown in FIG. 1) of the insulating substrate 1 (i.e., at both ends in the rightward/leftward direction shown in FIG. 1). The pair of back surface electrodes 8 correspond one to one to the pair of surface electrodes 3. Optionally, the pair of back surface electrodes 8 may be omitted.

In the chip resistor 10 according to this embodiment, the resistor body 2 preferably has a thickness equal to or greater than 5 μm and equal to or less than 15 μm, the undercoat protective film 4 preferably has a thickness equal to or greater than 4 μm and equal to or less than 20 μm, and the protective coating 5 preferably has a thickness equal to or greater than 20 μm and equal to or less than 40 μm. Setting the respective thicknesses of the resistor body 2, the undercoat protective film 4, and the protective coating 5 within these ranges makes it easier to reduce the difference in dimensional variation due to thermal expansion and shrinkage between the resistor body 2, the undercoat protective film 4, and the protective coating 5 and may also reduce the chances of causing cracking or chipping to the protective coating 5 or causing peeling between the undercoat protective film 4 and the protective coating 5.

2-2. Method for Fabricating Chip Resistor

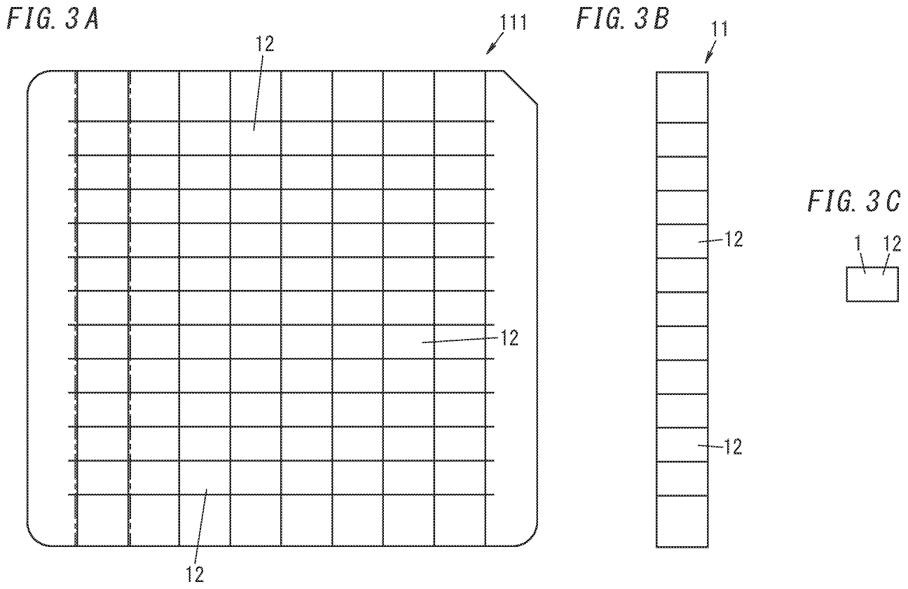

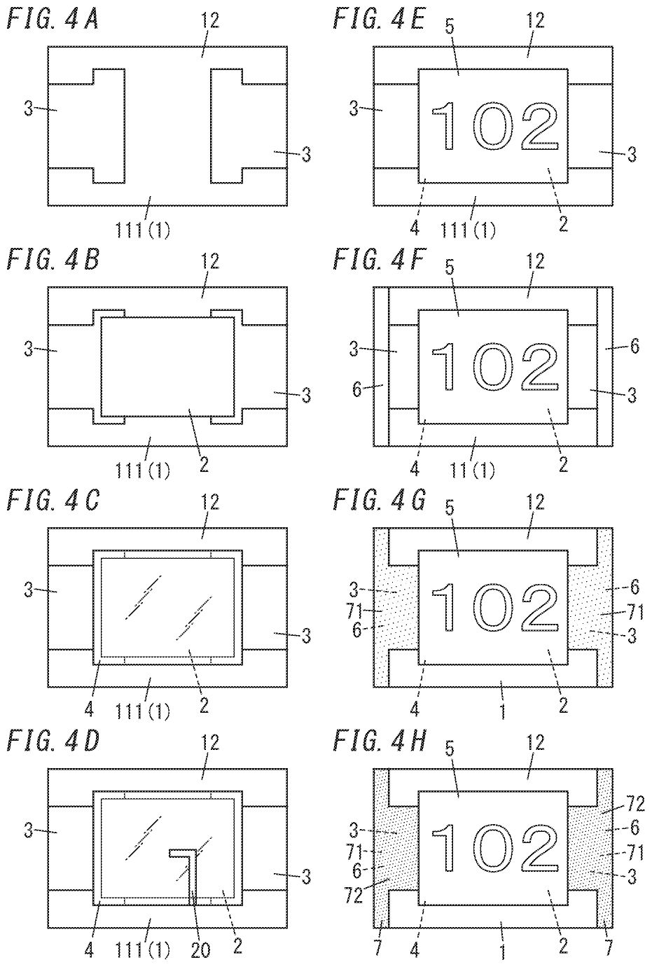

Next, a method for fabricating the chip resistor 10 according to this embodiment will be described with reference to FIGS. 3A-3C and FIGS. 4A-4H.

To form the chip resistor 10, a sheet-shaped insulating wafer 111 is used as shown in FIG. 3A. The sheet-shaped insulating wafer 111 is formed in a substantially rectangular shape in plan view and is formed of the same material as the insulating substrate 1 to the same thickness as the insulating substrate 1. The sheet-shaped insulating wafer 111 is formed to have larger dimensions than the insulating substrate 1 and to allow a plurality of insulating substrates 1 to be cut out of the sheet-shaped insulating wafer 111. On the sheet-shaped insulating wafer 111, a plurality of chip areas 12, each having the same dimensions as the insulating substrate 1, have been formed. Each chip area 12 corresponds to a single insulating substrate 1. That is to say, a single chip resistor 10 is fabricated by forming the resistor body 2, the protective coating 5, and other members on each chip area 12. The plurality of chip areas 12 are arranged side by side both vertically and laterally on the sheet-shaped insulating wafer 111. As will be described later, after the protective coating 5 has been formed, the sheet-shaped insulating wafer 111 will be divided into multiple strips of insulating substrates 11. Each strip of insulating substrates 11 includes a series of chip areas 12 which are arranged vertically as shown in FIG. 3B. Next, as will be described later, after the end face electrodes 6 have been formed, each strip of the insulating substrates 11 will be divided laterally to form an insulating substrate 1 having a single chip area 12 as shown in FIG. 3C.

Then, back surface electrodes (not shown in any of FIGS. 3A-3C and FIGS. 4A-4H) are formed first on the back surface of each chip area 12 of the sheet-shaped insulating wafer 111. Next, surface electrodes 3 are formed on the surface of each chip area 12 of the sheet-shaped insulating wafer 111 (refer to FIG. 4A). As a material for the surface electrodes 3 and the back surface electrodes, an Ag-based cermet conductive paste may be used, for example. The surface electrodes 3 and the back surface electrodes may be formed by, for example, screen-printing (applying) the conductive paste onto both longitudinal end portions of the surface and back surface of the chip area 12 and then sintering the conductive paste. Alternatively, the surface electrodes 3 and the back surface electrodes may also be formed by forming, by sputtering, a metal film at both longitudinal end portions of the surface and back surface of the chip area 12 and then removing excessive parts of the metal film by photolithographic and etching techniques.

After the surface electrodes 3 have been formed, a resistor body 2 is formed on the surface of each chip area 12 of the sheet-shaped insulating wafer 111 (refer to FIG. 4B). The resistor body 2 may be formed by, for example, screen-printing (applying) a resistor body paste including RuO₂ onto the surface of the chip area 12 and then baking the resistor body paste.

After the resistor body 2 has been formed, an undercoat protective film 4 is formed to cover the surface of the resistor body 2 (refer to FIG. 4C). The undercoat protective film 4 may be formed by, for example, screen-printing (applying) a glass coating agent onto each chip area 12 and then baking the glass coating agent.

After the undercoat protective film 4 has been formed, trimming is performed (refer to FIG. 4D). Trimming is conducted to adjust the resistance value of the chip resistor 10. Trimming is performed to form a trimmed portion 20 by partially removing the resistor body 2 and the undercoat protective film 4 from each chip area 12.

After trimming has been done, a protective coating 5 is formed to cover the surface of the undercoat protective film 4 (refer to FIG. 4E). The protective coating 5 may be formed by, for example, screen-printing (applying) a coating agent (to be described later) onto the chip area 12 and then curing the coating agent by heating, for instance. In addition, an indicator is also formed on the surface of the protective coating 5. In FIG. 4E, letters “102” are inscribed as the indicator. The indicator indicates, for example, the resistance value, product number, or model of the chip resistor 10. The indicator may be formed by, for example, printing ink (e.g., by stamping) onto the surface of the protective coating 5 and then curing the ink with heat or an ultraviolet ray, for instance.

After the protective coating 5 and the indicator have been formed, the sheet-shaped insulating wafer 111 is divided into elongate strips (which constitutes primary division), thereby forming a strip of insulating substrates 11 as shown in FIG. 3B. The cutting lines of the sheet-shaped insulating wafer 111 are indicated by one-dot chains in FIG. 3A. The sheet-shaped insulating wafer 111 is divided at both longitudinal ends of each chip area 12. Thus, a plurality of chip areas 12 are arranged side by side along the longitudinal axis of the strip of insulating substrates 11. In addition, the surface electrodes 3 formed in the respective chip areas 12 are also arranged side by side along the longitudinal axis of the strip of insulating substrates 11.

Next, end face electrodes 6 are formed in each chip area 12 (refer to FIG. 4F). The end face electrodes 6 are formed at both longitudinal ends of the strip of insulating substrates 11. The end face electrodes 6 may be formed by, for example, printing (applying) and curing a conductive paste. Alternatively, the end face electrodes 6 may also be formed by sputtering, for example.

After the end face electrodes 6 have been formed, the strip of insulating substrates 11 is divided into multiple chips diced for the respective chip areas 12 (which constitutes secondary division), thereby forming insulating substrates 1 as shown in FIG. 3C. Thereafter, an Ni plating layer 71 and an Sn plating layer 72 are formed sequentially to form a plating layer 7 (refer to FIGS. 4G and 4H). In this manner, a chip resistor 10 is completed. The chip resistor 10 will be shipped after being subjected to a completion inspection and taping.

2-3. Coating Agent

A coating agent according to this embodiment is used to form the protective coating 5. The coating agent includes a polyfunctional epoxy resin, a curing agent, an inorganic filler, and silicone rubber particles.

(A) Polyfunctional Epoxy Resin

The polyfunctional epoxy resin is cured with a curing agent to form the resin portion 50 of the protective coating 5. The polyfunctional epoxy resin is an epoxy resin having multiple epoxy groups per molecule. The polyfunctional epoxy resin comes to have a higher cross-linking density by curing than a monofunctional epoxy resin. Thus, compared to a situation where a monofunctional epoxy resin is used, the resin portion 50 of the protective coating 5 comes to have a higher glass transition point, thus improving the heat resistance of the protective coating 5.

As the polyfunctional epoxy resin, a polyfunctional epoxy resin expressed by any one of the following structural formulae (1) to (6) may be used. Specifically, the structural formula (1) expresses a tetrafunctional hydroxyphenyl epoxy resin. The structural formula (2) expresses a cresol-novolac epoxy resin. The structural formula (3) expresses a dicyclopentadiene epoxy resin. The structural formula (4) expresses an arylene epoxy resin. The structural formula (5) expresses a naphthalene diol epoxy resin. The structural formula (6) expresses a triphenol methane epoxy resin. In these structural formulae (1) to (6), n is an arbitrary integer.

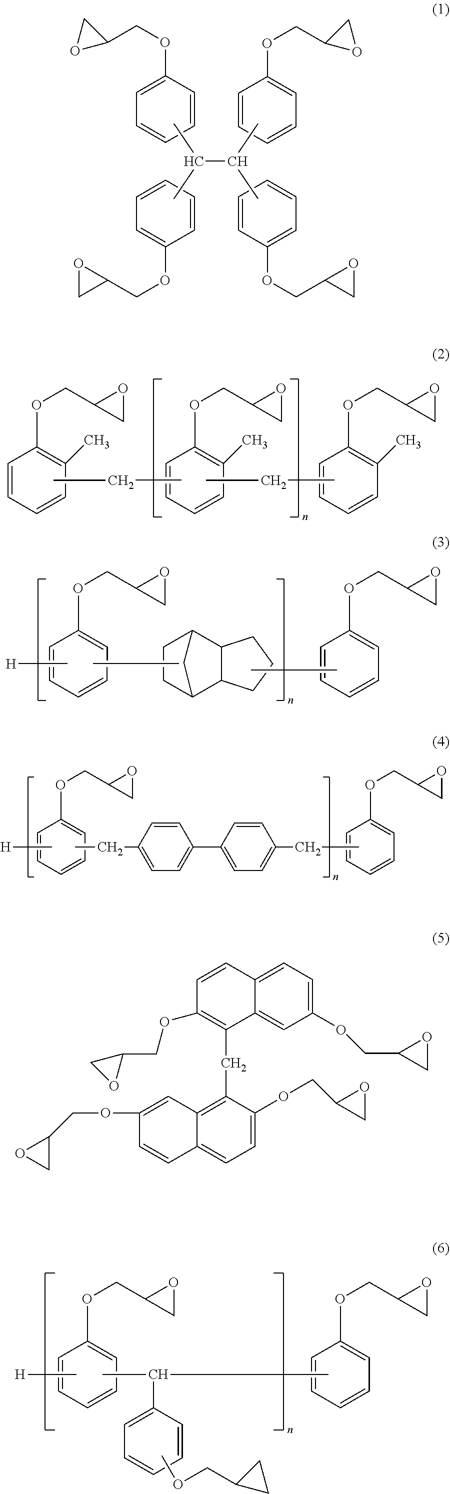

Among these polyfunctional epoxy resins, the tetrafunctional hydroxyphenyl epoxy resin expressed by the structural formula (1) is preferred. A hydroxyphenyl epoxy resin provides a cured product having higher flexibility than any other polyfunctional epoxy resin does. This reduces the chances of causing cracking or chipping to the protective coating at the time of a heat cycle test.

(B) Curing Agent

The curing agent is a curing agent for a polyfunctional epoxy resin. That is to say, the polyfunctional epoxy resin is cured by the curing agent to form the resin portion 50. As the curing agent, at least one selected from the group consisting of imidazole-based curing agents, phenol-novolac curing agents, and dicyandiamide curing agents may be used. As the imidazole-based curing agent, an imidazole-based curing agent expressed by the following structural formula (7) may be used. As the phenol-novolac curing agent, a phenol-novolac curing agent expressed by the following structural formula (8) may be used. As the dicyandiamide curing agent, a dicyandiamide curing agent expressed by the following structural formula (9) may be used. In these structural formulae (7) to (9), n is an arbitrary integer.

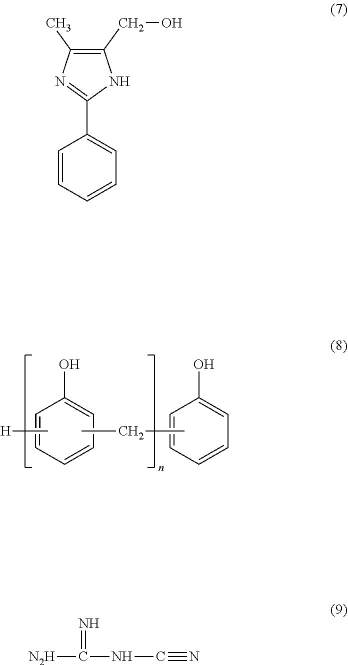

(C) Inorganic Filler

The inorganic filler is used to lower the coefficient of linear expansion of the protective coating 5. That is to say, the protective coating 5 including the inorganic filler has a smaller coefficient of linear expansion than a cured product of a resin including no inorganic fillers. Thus, the protective coating 5 according to this embodiment may be used to bring the coefficient of linear expansion thereof closer to the coefficient of linear expansion of the undercoat protective film 4 made of glass, for example, and may reduce the difference in coefficient of linear expansion between the protective coating 5 and the undercoat protective film 4. This reduces the difference in dimensional variation due to thermal expansion and shrinkage between the protective coating 5 and the undercoat protective film 4, thus reducing the chances of causing cracking to the protective coating 5 or causing peeling between the protective coating 5 and the undercoat protective film 4.

The inorganic filler preferably contains silica. Adding silica to the protective coating 5 allows the protective coating 5 to lower the coefficient of linear expansion thereof more easily. The silica is included as particles in the protective coating 5. The silica particles preferably have a mean particle size equal to or greater than 1 μm and equal to or less than 10 μm. If the mean particle size of the silica particles exceeded this range, then the thickness of the protective coating 5 should be increased, thus increasing the chances of causing cracking and peeling. On the other hand, if the mean particle size of the silica particles were short of this range, then the coating agent would tend to have an increased viscosity, thus possibly causing a decrease in the printability of the coating agent when the protective coating 5 is formed. The silica particles more preferably have a mean particle size equal to or greater than 1 μm and equal to or less than 5 μm.

Optionally, the silica may also be a blend of multiple types of particles with different mean particle sizes. Note that as the mean particle size of the silica particles, a median diameter (D50) obtained based on a particle size distribution measured by light scattering method may also be adopted.

(D) Silicone Rubber Particles

The silicone rubber particles are elastically deformed in the protective coating 5 to absorb the stress caused to the protective coating 5. Thus, the protective coating 5 including the silicone rubber particles is superior in stress relaxation ability to a cured product of a resin including no silicone rubber particles. This reduces, even when stress is caused to the protective coating 5 and the undercoat protective film 4 due to a dimensional variation involved with thermal expansion and shrinkage, the chances of causing cracking to the protective coating 5 or causing peeling between the protective coating 5 and the undercoat protective film 4.

As the silicone rubber particles, silicone rubber particle, having a structure in which straight-chain dimethylpolysiloxane is cross-linked, may be used, for example. Alternatively, to increase the dispersibility of the silicone rubber particles into the resin, the silicone rubber particles may have their surface coated with a silicone resin.

The silicone rubber particles preferably have a mean particle size equal to or greater than 2 μm and equal to or less than 15 μm. If the mean particle size of the silicone rubber particles exceeded this range, then the thickness of the protective coating 5 should be increased, thus increasing the chances of causing cracking or peeling. On the other hand, if the mean particle size of the silicone rubber particles were short of this range, then the coating agent would tend to have an increased viscosity, thus possibly causing a decrease in the printability of the coating agent when the protective coating 5 is formed. The silicone rubber particles more preferably have a mean particle size equal to or greater than 3 μm and equal to or less than 8 μm. The mean particle size of the silicone rubber particles may be measured in the same way as the silica particles.

The silicone rubber particles preferably have a rubber hardness equal to or greater than 10 and equal to or less than 35 when measured with a durometer A. If the rubber hardness of the silicone rubber particles exceeded this range, then the stress would be reduced much less effectively by the silicone rubber particles. On the other hand, if the rubber hardness of the silicone rubber particles were short of this range, then the silicone rubber particles would coagulate more easily to cause a decrease in dispersibility in the coating agent. Note that the silicone rubber particles more preferably have a rubber hardness equal to or greater than 10 and equal to or less than 20. Meanwhile, the silicone rubber particles coated with a silicone resin preferably have a rubber hardness equal to or greater than 10 and equal to or less than 30. Although acrylic rubber is sometimes used as rubber particles, there are no acrylic rubber particles having a rubber hardness equal to or less than 35. Thus, from the viewpoint of rubber hardness, silicone rubber particles are preferred to acrylic rubber particles.

(E) Other Components

Optionally, the coating agent may further include, as needed, a pigment such as carbon and a solvent for adjusting the viscosity.

(F) Blending Quantities

The coating agent contains silica as an inorganic filler at a content equal to or greater than 60% by weight and equal to or less than 90% by weight and silicone rubber particles at a content equal to or greater than 1% by weight and equal to or less than 15% by weight with respect to the solid content in the coating agent (i.e., the rest of the coating agent other than the solvent). Note that the protective coating 5 as a cured product of the coating agent is formed as the solid content of the coating agent. Thus, the protective coating 5 also preferably contains silica at a content equal to or greater than 60% by weight and equal to or less than 90% by weight and silicone rubber particles at a content equal to or greater than 1% by weight and equal to or less than 15% by weight.

If the blending quantity of the silica were less than 60% by weight, then the stress caused to the protective coating 5 would sometimes be reduced much less significantly. On the other hand, if the blending quantity of the silica were greater than 90% by weight, then the viscosity of the coating agent would be too high to avoid affecting printability in some cases. Thus, from the viewpoints of the stress relaxation ability and printability, the blending quantity of the silica is preferably equal to or greater than 60% by weight and equal to or less than 75% by weight with respect to the solid content in the coating agent.

If the blending quantity of the silicone rubber particles were less than 1% by weight, then the stress would be reduced much less effectively by the silicone rubber particles. On the other hand, if the blending quantity of the silicone rubber particles were greater than 15% by weight, then the silicone rubber particles would coagulate more easily to cause a decrease in dispersibility in the coating agent and cause a decline in the printability of the coating agent in some cases. Thus, from the viewpoints of the stress relaxation ability and printability, the blending quantity of the silicone rubber particles is preferably equal to or greater than 2% by weight and equal to or less than 8% by weight with respect to the solid content in the coating agent.

Note that the blending quantities of components other than the silica and the silicone rubber particles may be set appropriately with the properties the protective coating 5, manufacturability thereof, and other factors taken into account.

### EXAMPLES

### Examples 1-3 and Comparative Examples 1 and 2

The chip resistor 10 shown in FIG. 1 was fabricated by performing the process steps shown in FIGS. 3A-3C and FIGS. 4A-4H. As the coating agent, a coating agent having any of the compositions shown in the following Table 1 was used. The insulating substrate was an alumina substrate having a coefficient of linear expansion of 7 ppm and an elastic modulus of 360 GPa. The undercoat protective film had a coefficient of linear expansion of 7 ppm and an elastic modulus of 59 GPa and was crystal glass made of a glass material including 20% of silicon dioxide, 30% of lead oxide, and a solvent and other components as the balance. The protective coating 5 according to Example 1 had a coefficient of linear expansion (α2) of 40 ppm, a coefficient of linear expansion (α1) of 10 ppm, and an elastic modulus of 18 GPa.

As the silica particles, silica particles having a mean particle size of 3 μm were used.

As the silicone rubber particles, silicone rubber particles having a mean particle size of 3 μm and a rubber hardness of 15 were used.

Then, each of the chip resistors 10 according to Examples 1 to 3 and Comparative Examples 1 and 2 was subjected to a heat cycle test and a humidity load life test. In the heat cycle test, the ambient temperature in the environment surrounding the chip resistor was changed repeatedly from a low temperature of −55° C. to a high temperature of 175° C., and vice versa, over 1000 cycles, and then the properties of the protective coating 5 were observed. In the humidity load life test, with a voltage of 100 V applied to the chip resistor, the atmosphere surrounding the chip resistor was maintained at 60° C. and 95% for 1000 hours, and a variation in resistance value during the period was measured.

The results are summarized in the following Table 1:

TABLE 1

| | | Solid | | Heat cycle test | Humidity load life test |
|---|---|---|---|---|---|
| | | content | | (−55° C./175° C., | (60° C., 95%, 100 V |
| | Blend | ratio | | 1000 cycles) | applied, 1000 hours) |
| Ex.1 | Tetrafunctional hydroxyphenyl | 28 | wt % | No peeling | Resistance value |
| | epoxy resin, 100 g | | | or chipping | variation ≤1% |
| | Imidazole curing agent, 5 g | 1.3 | wt % | | |
| | Silica particles, 235 g | 65.8 | wt % | | |
| | Silicone rubber particles, 15 g | 4.3 | wt % | | |
| | Carbon, 2g | 0.6 | wt % | | |
| | Solvent (ethyl carbitol), 50 g | | | | |
| Ex.2 | Naphthalene diol epoxy | 25.2 | wt % | No peeling | Resistance value |
| | resin, 100 g | | | or chipping | variation ≤1% |
| | Dicyandiamide curing | 1.3 | wt % | | |
| | agent, 5 g | | | | |
| | Silica particles, 285 g | 71.7 | wt % | | |
| | Silicone rubber particles, 5 g | 1.3 | wt % | | |
| | Carbon, 2 g | 0.5 | wt % | | |
| | Solvent (butyl carbitol), 50 g | | | | |
| Ex.3 | Dicyclopentadiene epoxy | 27.2 | wt % | No peeling | Resistance value |
| | resin, 100 g | | | or chipping | variation: 1.8% |
| | Imidazole curing agent, 5 g | 1.4 | wt % | | |
| | Silica particles, 235 g | 64.0 | wt % | | |
| | Silicone rubber particles, 25 g | 6.8 | wt % | | |
| | Carbon, 2 g | 0.6 | wt % | | |
| | Solvent (butyl carbitol), 50 g | | | | |
| Cmp. | Tetrafunctional hydroxyphenyl | 29.2 | wt % | Protective coating | Resistance value |
| Ex.1 | epoxy resin, 100 g | | | peeled | variation: 1.8% |
| | Imidazole curing agent, 5 g | 1.5 | wt % | | |
| | Silica particles, 235 g | 68.7 | wt % | | |
| | Silicone rubber particles, 0 g | 0 | wt % | | |
| | Carbon, 2 g | 0.6 | wt % | | |
| | Solvent (ethyl carbitol), 50 g | | | | |
| Cmp. | Tetrafunctional hydroxyphenyl | 39.7 | wt % | Protective coating | Resistance value |
| Ex.2 | epoxy resin, 100 g | | | uplifted from precoat | variation: 1.5% |
| | Imidazole curing agent, 5 g | 2 | wt % | glass surface | |
| | Silica particles, 130 g | 51.6 | wt % | | |
| | Silicone rubber particles, 15 g | 5.9 | wt % | | |
| | Carbon, 2 g | 0.8 | wt % | | |
| | Solvent (ethyl carbitol), 50 g | | | | |

(Recapitulation)

As can be seen from the foregoing description, a chip resistor (10) according to a first aspect includes, a resistor body (2), and a protective coating (5) that covers the resistor body (2). The protective coating (5) is a cured product of a coating agent containing a polyfunctional epoxy resin, a curing agent, an inorganic filler, and silicone rubber particles. The coating, agent contains silica as the inorganic filler at a content equal to or greater than 60% by weight and equal to or less than 90% by weight and also contains the silicone rubber particles at a content equal to or greater than 1% by weight and equal to or less than 15% by weight.

According to this aspect, the silica and the silicone rubber particles (52) improve the stress relaxation ability of the protective coating (5), thus achieving the advantages of reducing the chances of causing peeling between the protective coating (5) and the underlying member and reducing the chances of water entering the chip resistor (10) through a gap between the protective coating (5) and the underlying member.

In a chip resistor (10) according to a second aspect, which may be implemented in conjunction with the first aspect, the silica is particles (51) having a mean particle size equal to or greater than 1 μm and equal to or less than 10 μm. The silicone rubber particles (52) have a mean particle size equal to or greater than 2 μm and equal to or less than 15 μm and have a rubber hardness equal to or greater than 10 and equal to or less than 35 when measured with a durometer.

According to this aspect, the silica particles (51) and the silicone rubber particles (52) further improve the stress relaxation ability of the protective coating (5), thus achieving the advantages of reducing the chances of causing peeling between the protective coating (5) and the underlying member and reducing the chances of water entering the chip resistor (10) through the gap between the protective coating (5) and the underlying member.

In a chip resistor (10) according to a third aspect, which may be implemented in conjunction with the first or second aspect, the polyfunctional epoxy resin includes a tetrafunctional hydroxyphenyl epoxy resin.

This aspect achieves the advantages of increasing the flexibility of the protective coating (5), further improving the stress relaxation ability of the protective coating (5), reducing the chances of causing peeling between the protective coating (5) and the underlying member, and reducing the chances of water entering the chip resistor (10) through the gap between the protective coating (5) and the underlying member.

### REFERENCE SIGNS LIST

10 Chip Resistor
2 Resistor Body
5 Protective Coating
51 Silica Particle
52 Silicone Rubber Particle

1. A chip resistor comprising: a resistor body; and a protective coating that covers the resistor body,
the protective coating being a cured product of a coating agent containing a polyfunctional epoxy resin, a curing agent, an inorganic filler, and silicone rubber particles,
the coating agent containing silica as the inorganic filler at a content equal to or greater than 60% by weight and equal to or less than 90% by weight and also containing the silicone rubber particles at a content equal to or greater than 1% by weight and equal to or less than 15% by weight.

2. The chip resistor of claim 1, wherein
the silica is particles having a mean particle size equal to or greater than 1 μm and equal to or less than 10 μm, and
the silicone rubber particles have a mean particle size equal to or greater than 2 μm and equal to or less than 15 μm and have a rubber hardness equal to or greater than 10 and equal to or less than 35 when measured with a durometer.

3. The chip resistor of claim 1, wherein
the polyfunctional epoxy resin includes a tetrafunctional hydroxyphenyl epoxy resin.

4. The chip resistor of claim 2, wherein
the polyfunctional epoxy resin includes a tetrafunctional hydroxyphenyl epoxy resin.
